(19) United States
(12) Patent Application Publication
(10) Pub. No.: US 2005/0131786 A1
(43) Pub. Date: Jun. 16, 2005

(54) Risk shifting for financing intellectual property litigation

(76) Inventor: Robert Bender, Ottawa (CA)

Correspondence Address: LAHIVE & COCKFIELD, LLP., 28 STATE STREET, BOSTON, MA, 02109, US

(21) Appl. No.: 10/714,264

(22) Filed: Nov. 14, 2003

Related U.S. Application Data
(60) Provisional application No. 60/426,631, filed on Nov. 14, 2002.
(60) Provisional application No. 60/427,614, filed on Nov. 19, 2002.

(51) Int. Cl. G06F 17/60

(52) U.S. Cl. 705/35

(57) ABSTRACT

A method for risk shifting in intellectual property litigation is described.

### RELATED APPLICATIONS

This application claims priority to U.S. Provisional Application Ser. No. 60/427,614, filed Nov. 19, 2002; and U.S. Provisional Application Ser. No. 60/426,631, filed Nov. 14, 2002, the entire contents of each of which are hereby incorporated herein by reference.

### BACKGROUND OF THE INVENTION

Intellectual property litigation costs as well as the uncertainty of outcomes create a market inefficiency relative to the enforcement of small and medium companies' rights. In addition, there are barriers due to the expertise required to assess and manage litigation strategies. Few legal firms are willing or able to risk contingency engagement in this highly technical area. Large companies generally view the costs of patent litigation as a strategic advantage and are disproportionately willing to risk infringement of the rights of smaller entities. There is no meaningful risk insurance available on a case basis and financing single cases is fraught with technical and financial risks.

### SUMMARY

In one embodiment, the invention pertains at least in part, to a business method for financing intellectual property litigation. The method includes obtaining a pool of funds from one or more investors, selecting intellectual property litigation, wherein an owner of intellectual property under litigation pays to the pool of funds a predetermined amount, financing from the pool of funds the intellectual property litigation, and apportioning any profit resulting from a settlement of said intellectual property litigation between at least said investors, and the owner of the intellectual property under dispute, thus financing the intellectual property litigation.

### DETAILED DESCRIPTION OF THE INVENTION

Analysis of a class of situations, namely those in which granted rights are infringed, suggests that the expectation of success (Ps) in prosecution is well in excess of 50% and may, in cases where a patent has been re-examined, be much higher. Case data suggests that there is a significant expectation of ‘profit’ (i.e., excess of settlement value (SV) over direct litigation costs) for such cases and that the average cash value of a case which proceeds as far as trial is at least three times the cost.

Accordingly, if for a representative class of cases the cost of mounting and prosecuting an action is exceeded by the product (Ps) x (SV), there is an opportunity to create a funding instrument which (depending on the characteristics of the distribution of outcomes and the number of cases) can have an overall expectation of profit. The risk depends significantly on the characteristics of the distribution and number of cases pooled.

Such a funding instrument is dependent on an informed selection of cases and presumes the ability to obtain a representative and sufficient sample of cases. It is advantageous that the owner of the intellectual property retain an interest in the matter to be litigated (e.g., patent), both to qualify risk and also maintain access to information required for case management. Risk mitigation for the owner is desirable both due to the absolute amounts at risk in such disputes and also due to the uncertainty of outcome of any single case.

Accordingly, a novel instrument (‘IPSO’) allows individual intellectual property, e.g., patent, infringement cases to be partially financed through an aggregate pool which allows a statistical expectation of return to the pool investors. This allows a well-defined statistical expectation of return to the pool investors over a number of cases and a significant direct return to the owner of the intellectual property in the case of particular success. Although the intellectual property owner remains at risk for a defined amount, the owner should benefit from the long term outcome of having a validated intellectual property position, as well as having the depth to engage in and manage IP-based litigation.

The invention pertains at least in part, to a business method for financing intellectual property litigation. The method includes obtaining a pool of funds from one or more investors, selecting intellectual property litigation, wherein an owner of intellectual property under litigation pays to the pool of funds a predetermined amount, financing from the pool of funds the intellectual property litigation, and apportioning any profit resulting from a settlement of said intellectual property litigation between at least said investors, and the owner of the intellectual property under dispute, thus financing the intellectual property litigation.

In one embodiment, thirty or more, forty or more, fifty or more, sixty or more, or one hundred or more intellectual property disputes are selected and financed through the pool of funds. In a further embodiment, the intellectual property disputes are selected by experts in the field for an enhanced expectation of success. The experts may include legal professionals such as patent attorneys, business experts, scientists, etc.

In a further embodiment, any resulting profit from the patent litigation is apportioned between, for example, the investors, the patent owner, and, optionally, the pool of funds.

For example, an intellectual property owner may be required to participate for a minimum amount and up to a threshold maximum and would be entitled to preferential cost recovery from any settlement. The owners (financial sources) of the pool instrument would own the balance of any settlement and bear the risk of all costs above the threshold minimum. Case selection and management based on specific information are important attributes of the pool management and implicit in this business model.

Equivalents

Those skilled in the art will recognize, or be able to ascertain using no more than routine experimentation, many equivalents to the specific embodiments of the invention described herein. Such equivalents are intended to be encompassed by the following claims.

1. A business method for financing intellectual property litigation, comprising:
obtaining a pool of funds from one or more investors; selecting intellectual property litigation, wherein an owner of intellectual property under litigation pays to said pool of funds a predetermined amount;
financing from said pool of funds said intellectual property litigation; and
apportioning profit resulting from a settlement of said intellectual property litigation between at least said investors, and the owner of said intellectual property under dispute.

2. The method of claim 1, wherein thirty or more intellectual property disputes are selected.

3. The method of claim 1, wherein said intellectual property disputes are selected by expert analysis.

4. The method of claim 1, wherein said intellectual property dispute is a patent dispute.
